(19) United States
(12) Patent Application Publication
(10) Pub. No.: US 2018/0257486 A1
(43) Pub. Date: Sep. 13, 2018

(54) AUXILIARY PROPULSION SYSTEM

(71) Applicant: AMPSTICK, INC., Branford, CT (US)

(72) Inventors: Eduardo Alejandro Noble Nava, Branford, CT (US); Zhe Kevin Wang, Branford, CT (US)

(73) Assignee: AMPSTICK, INC., BRANFORD, CT (US)

(21) Appl. No.: 15/916,219

(22) Filed: Mar. 8, 2018

Related U.S. Application Data
(60) Provisional application No. 62/468,914, filed on Mar. 8, 2017.

(51) Int. Cl. B60K 17/30; A63C 17/12; B60B 19/00; B60K 7/00

(52) U.S. Cl. CPC B60K 17/30; A63C 17/12; A63C 17/01; B60K 7/0007; B60B 19/003

(57) ABSTRACT

An auxiliary propulsion system for a skateboard, watercraft or other small vehicle has a wheel or propeller powered by a motor at one end and a handle at the other end. A person riding a vehicle adjusts the position and orientation of the device to apply a propulsion force in a desired direction. The amount of torque applied to the propeller or wheel can be adjusted in real time. Because the propulsion system is not a fixed to the craft or person it is propelling, it may be exchanged between people in mid-transit.

### BACKGROUND OF THE INVENTION

### Field of the Invention

The present invention relates to an auxiliary propulsion system for a human powered vehicle. More particularly, the invention relates to auxiliary propulsion systems primarily for use with hands free unmotorized vehicles to enhance overall performance and dynamics of the vehicle.

### Description of the Related Art

Hands free human powered vehicles, such as skateboards and roller skates, are typically used for transportation and sport. These vehicles require a rider to provide the propelling force, typically by pushing off with one foot. This manual propulsion is limited in speed, acceleration, and range based on the strength and endurance of the rider. To alleviate these shortcomings, a number of motorized skateboards and roller skates have been developed.

Current solutions come with substantial deficiencies. Heavy electrical components such as motors and batteries are attached to the vehicle, thus increasing the weight substantially. The increased weight reduces the functionally of the vehicle, specifically in riding dynamics. The additional weight also makes these devices unsuitable for many recreational uses. The motors are typically permanently coupled to the wheels, either through a geared drivetrain or direct driven. This results in permanent increase in drag, limiting the functionality of the vehicles for unassisted use. It is advantageous to be able to decouple the drive mechanism to the wheels to coast when desired. An additional problem with driving the wheels is obvious when observing the force balance of the rider. The center of gravity of the rider is significantly above the wheels, so whenever the device is accelerated or decelerated, it creates an imbalance. This further decreases the functionality and limits performance. Lastly, since current solutions require components that are permanently attached to the vehicle, it is difficult to use the drive components on multiple vehicles as each application has very distinct requirements and interfaces.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide devices and systems for motorized propulsion of any skateboard or similar device.

### BRIEF SUMMARY OF THE INVENTION

Disclosed is an auxiliary propulsion system.

In one embodiment, the auxiliary propulsion device comprises of a pole having a distal end and a proximal end. A wheel actuated by a motor is located at the distal end of the pole. The proximal end consists of a handle and trigger with which the user can control the speed of the motor and wheel. The user may hold the pole at the proximal end while applying the wheel at the distal end to the ground. The user has the ability to adjust not only the power provided to the motor but also the position of the wheel on the distal end of the pole. Thus, the user is able to engage or disengage the wheel from the surface at any time. This allows the user to more efficiently use the power available, by choosing when to receive auxiliary propulsion or braking. Since the device is separate from the vehicle, the device can also be used for additional stability. Due to the fact the user is holding the device with his/her hands, the propulsion force is applied closer to the user's center of gravity, thus providing better control and balance. Having the device be separate from the vehicle also has an added benefit to be used on multiple vehicles.

In another embodiment, the skateboard propulsion system comprises a pole having a distal end and a proximal end. A wheel actuated by a motor is located at the distal end of the pole. Controls for adjusting power to the motor and a handle are located at the proximal ends. The handle may include a trigger switch that controls the output of the motor. A skateboarder, while riding a skateboard, may hold the pole at the proximal end while applying the wheel at the distal end to the ground. The skateboarder may then control the motor in order to apply propulsion to himself or herself and the skateboard. The user has the ability to adjust not only the power provided to the motor but also the position of the wheel on the distal end of the pole. Thus, the user is able to engage or disengage the wheel from the surface at any time. This allows the user to more efficiently use the power available, by choosing when to receive auxiliary propulsion or braking. Since the device is separate from the vehicle, the device can also be used for additional stability. Due to the fact the user is holding the device with his/her hands, the propulsion force is applied closer to the users center of gravity, thus providing better control and balance. Having the device be separate from the vehicle also has an added benefit to be used on multiple vehicles.

While riding the skateboard, the skateboarder may adjust not only the power provided to the motor but also the position of the wheel on the distal end of the pole. Thus, the skateboarder may alternate between applying propulsion between the left and right sides of the skateboard and also adjust the angle or direction of the wheel relative to the longitudinal axis of the skateboard.

It is therefore an object of the present invention to provide devices and systems for providing propulsion to a skateboard and skateboarder that gives the skateboarder increase control of how the propulsion is applied during travel.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE SEVERAL VIEWS OF THE DRAWINGS

A more complete understanding of the present invention, and the attendant advantages and features thereof, will be more readily understood by reference to the following detailed description when considered in conjunction with the accompanying drawings wherein:

FIG. 1 is a side elevation view of an auxiliary propulsion system in accordance with the principles of the invention;

FIG. 2 is a side cross-sectional view of an auxiliary propulsion system in accordance with the principles of the invention;

FIG. 2A is an enlarged side view of a proximal end of an auxiliary propulsion system in accordance with the principles of the invention;

FIG. 3 is an environmental perspective view of an auxiliary propulsion system in accordance with the principles of the invention;

FIG. 4 is a schematic diagram of various electrical components of an auxiliary propulsion system in accordance with the principles of the invention;

FIG. 5 is an exploded perspective view a motor assembly inside a wheel of an auxiliary propulsion system in accordance with the principles of the invention;

FIG. 6 is a perspective view of interchangeable propulsion devices for an auxiliary propulsion system in accordance with the principles of the invention;

FIG. 7 is a side elevation view of an alternative embodiment of a telescoping auxiliary propulsion system in an extended position in accordance with the principles of the invention;

FIG. 8 is a side elevation view of an alternative embodiment of a telescoping auxiliary propulsion system in a retracted position in accordance with the principles of the invention;

FIG. 9 is a side elevation view of another alternative embodiment of a folding auxiliary propulsion system in an open position in accordance with the principles of the invention;

FIG. 10 is a side elevation view of another alternative embodiment of a folding auxiliary propulsion system in a closed position in accordance with the principles of the invention;

FIG. 11 is a side elevation view of an alternative embodiment of a mounting arm for an auxiliary propulsion system in accordance with the principles of the invention;

FIG. 12 is a side elevation view of another alternative embodiment of a mounting arm for an auxiliary propulsion system in accordance with the principles of the invention;

FIG. 13 is a perspective view of an auxiliary propulsion system in accordance with the principles of the invention;

FIG. 14 is another perspective view of an auxiliary propulsion system in accordance with the principles of the invention;

FIG. 15 is an environmental view of an auxiliary propulsion system in accordance with the principles of the invention;

FIG. 16 is a side elevation view of an alternative embodiment of an auxiliary propulsion system for watercraft in accordance with the principles of the invention;

FIG. 17 is a cut-away side view of an alternative embodiment of an auxiliary propulsion system in accordance with the principles of the invention.

### DETAILED DESCRIPTION OF THE INVENTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

The term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Additionally, as used herein, the “longitudinal axis” refers to an imaginary line running from the front of a skateboard to the back of the skateboard. The “transverse axis” refers to an imaginary line running perpendicular to the longitudinal axis in the center of the skateboard. “Front” and “forward” generally refer to the front of the skateboard and the region in front of the skateboard, while “back” and “rear” refer to the back of the skateboard in the region behind the skateboard. The “ground” is generally considered to be substantially horizontal but may also be on an angle such as when the skateboard is on a hill. “Up” and “down” generally refer to directions away from and toward the ground, respectively.

Disclosed is an auxiliary propulsion system having an elongate pole. The distal end of the pole includes a wheel and the proximal end of the pole includes a handle. Controls operable by the rider regulate the speed of the motor and wheel. The controls may include an accelerometer that automatically shuts off the motor when the wheel is spinning but the location is not changing. This may improve safety in the event of an accident. The invention is described herein as relating primarily to an auxiliary propulsion system for a skateboard and as being operated by a skateboarder or skateboard rider. Optionally, the device may be used for other forms of propulsion. For example, the wheel may comprise a propeller so that the propulsion system may be used by when riding a paddleboard.

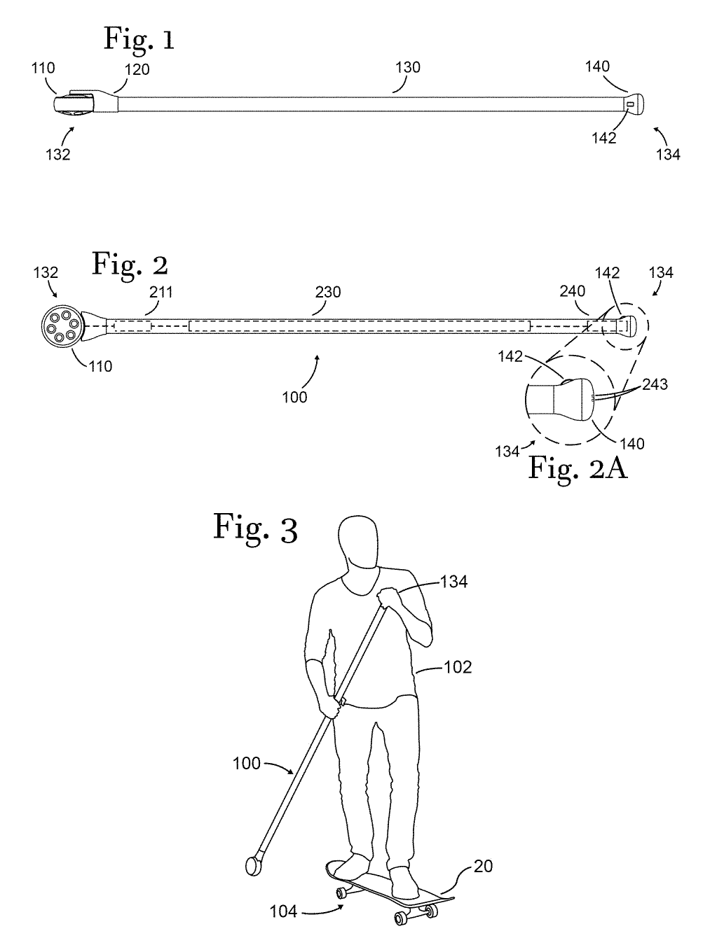

FIG.1 is an elevational side view of the auxiliary propulsion device 100 in accordance with the principles of the invention. The auxiliary propulsion device 100 has an elongate pole 130 with a proximal end 132 and a distal end 134. A motorized wheel 110 is located at the distal end 134, while a handle 140 is located at the proximal end 132. The motorized wheel 110 is attached to the elongate pole 130 by a mounting arm 120. The mounting arm 120 optionally includes a suspension device. The handle 140 has a trigger 142 that allows the user to vary the speed of the motorized wheel 110.

FIG. 2 is a cross-sectional side elevation view of the auxiliary propulsion device 100 in accordance with the principles of the invention. In this embodiment, the motorized wheel 110 is controlled by a motor controller 211 located inside the elongate pole 130. The handle 140 contains a trigger control unit 240 that communicates with the motor controller 211 to vary the propulsion characteristics of the motorized wheel 110. The motor controller 211 and trigger control unit 240 are be powered by a battery pack 230 located inside the elongate pole 130. The handle 110 is ergonomically shaped so as to be engageable from a plurality of angles. The handle 110 is useable by both right handed and left handed riders. FIG. 2A shows an enlarged view of the proximal end 134 of the auxiliary propulsion device 100. Two indicator lights 243 are located on the handle 140 and display various illumination patterns indicating the current status of the device 100.

FIG. 3 is an environmental perspective view of the auxiliary propulsion device 100 being used by an operator 102 on a vehicle 104. The vehicle 20 of this embodiment is a skateboard. The operator 102 grips the auxiliary propulsion device at the proximal end 134 with one hand, and grips the device by the pole 130 with the other hand. The operator 102 changes the angle of contact with the ground by altering the angle of the auxiliary propulsion device 100. The operator 102 also easily disengages the auxiliary propulsion device 100 from the ground by lifting it from the surface. This allows the operator 102 to use the propulsive abilities of the auxiliary propulsion device 100 power more efficiently by choosing when to coast, when to manually propel oneself, and when to receive auxiliary propulsion. The operator 102 also uses the auxiliary propulsion device 100 for added balance and stability, as it adds another point of contact with the ground. The operator 102 also uses the auxiliary propulsion device 100 to assist in maneuvering by altering the angle of contact with the ground. The operator 102 may also position the auxiliary propulsion device 100 on any side of the vehicle 104. Because the auxiliary propulsion device 100 is separate from and not connected to the vehicle 104, the operator 102 can use the device on any nearby surfaces, such as walls and ramps, for both propulsion, stability, and maneuverability. Optionally, the auxiliary propulsion device 100 may provide for deceleration by regenerative braking from the motorized wheel and/or by the drag of the motorized wheel.

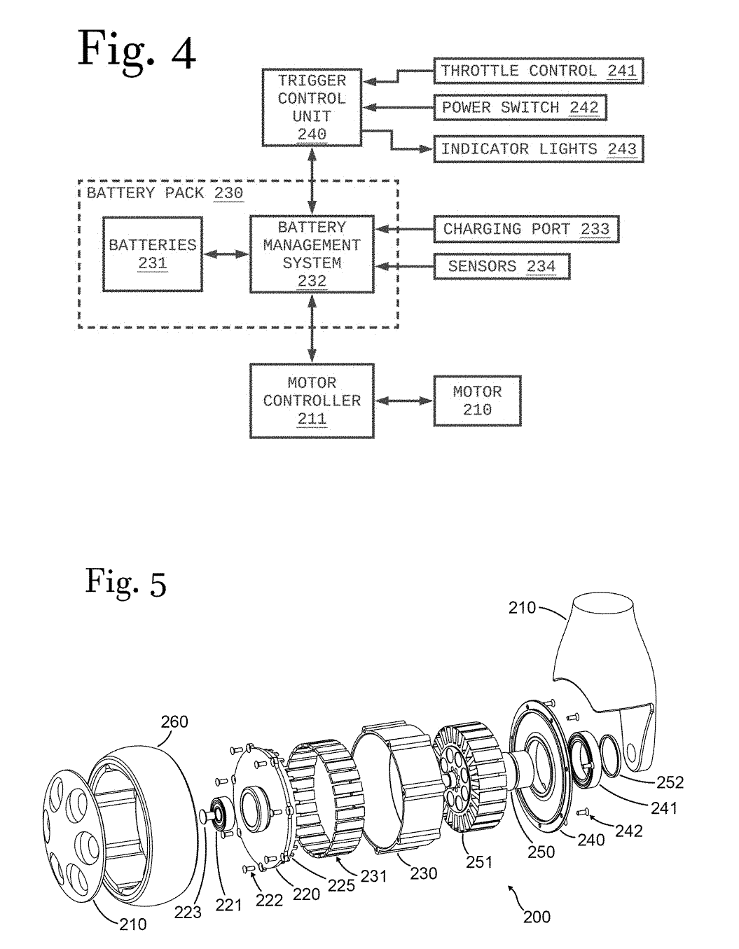

FIG. 4 is a schematic diagram of the various electrical components within the auxiliary propulsion device 100. The main components of this embodiment are the trigger control unit 240, battery pack 230, motor controller 211, and motor 210. The battery pack 230 of this embodiment includes one or more batteries 231 and a battery management system 232. The trigger control unit 240 is in electrical communication with the battery management system 232. The trigger control unit 240 may receive and/or send power and communication through a plurality of wires. The trigger control unit 240 may optionally include a printed circuit board and various components, such as for example a microcontroller. The trigger control unit 240 is in communication with a throttle control 241 through a digital or analog signal. Based on the position of the throttle control 241, the trigger control unit may convert the signal to a communication format to send it through the battery management system 232 to the motor controller 211. The power switch 242 may optionally be connected to, and thus in electrical communication with, the trigger control unit 240 through two or more wires. Indicator lights 243 may optionally be connected to the trigger control unit 240 through a plurality of wires or traces. The indicator lights 243 include one or more lights capable of displaying a plurality of illumination patterns that may signify various conditions of the auxiliary propulsion device 100. For example, the indicator lights 243 may signify whether or not the auxiliary propulsion device 100 is turned on or off. The indicator lights 243 may also signify whether or not the auxiliary propulsion device 100 is facing an error. The indicator lights 243 may also signify whether or not the auxiliary propulsion device 100 is charging. The indicator lights 243 may also signify the condition of the battery pack 230.

The battery management system 232 includes a printed circuit board and various components, such as a microcontroller. The battery management system 232 monitors the state of charge of the batteries 231. The battery management system 232 also optionally monitors the health of the batteries 231. For example, the battery management system 232 optionally monitors the temperature of the batteries 231 through sensors 234. The battery management system 232 may disconnect the battery 231 from the rest of the device if the power switch 242 is off. A charging port 233 can connect to the battery management system 232 through two or more wires. When a charger is plugged into the charging port 233, the battery management system 232 controls the energy to each of the cells in the batteries 231. Various sensors 234 can be connected to the battery management system 232. Sensors 234 measure temperature, humidity, altitude, location, orientation, etc. The battery management system 232 may also optionally include logic to throttle the battery pack output to the motor controller 211 if past a certain temperature threshold. The battery management system 232 may optionally shut down the batteries if it senses conditions that may cause permanent damage. The batteries 231 of this embodiment are formed by a plurality of cells. The batteries 231 can comprise of any type and shape of battery. The battery pack 230 of this embodiment is replaceable and encased in a protective shell.

The motor controller 211 can consist of a printed circuit board with microcontroller(s). The motor controller 211 can be connected to, and thus in electrical communication with, the battery management system 232 through a plurality of wires. Two or more of the wires from the battery management system 232 and motor controller 211 can handle high voltage and current. The motor controller 211 can send and receive communication with the battery management system 232 and trigger control unit 240. The motor controller 211 can contain components required to convert DC voltage from the battery pack 230 to alternating current. The motor controller 211 can contain components required to generate three phase alternating current to drive the motor 210. The motor controller 211 can contain logic to sense the position of the motor 210 without sensors. The motor controller 211 can contain logic for Field Oriented Control. The motor controller 211 can contain logic for regenerative braking.

FIG. 5 is an exploded perspective view of the motorized wheel 110. The motorized wheel 110 includes an internal electric motor assembly 200, which may optionally be either direct driven or geared. Those skilled in the art will appreciate that there are several types of electric motors, such as DC motors, permanent magnet synchronous motors, induction motors, and reluctance motors. The electric motor assembly 220 may include a three phase permanent magnet synchronous motor. The motorized wheel 110 is removably and securely attached to the mounting arm 120 by the axle 250.

The motor assembly 200 includes a stator 251 fixedly attached to the axle 250 which is formed by an assembly of electrical steel laminations and wires. The stator 251 in this embodiment has a plurality of teeth wrapped in copper wire which form electromagnetic fields when energized. The first bearing 221 is attached to the axle 250 by a bolt 223. The first bearing 221 of this embodiment includes an inner race and an outer race, which rotate relative to each other with low drag. The first bearing 221 contains ball bearings or roller bearings between the inner and outer race. The second bearing 241 and spacer 252 attach to the axle 250. The second bearing 241 is similar to the first bearing 221 in features, such as having an inner race, an outer race, and rolling elements to reduce friction and drag. The second bearing 241 is a different in size to the first bearing 221, but those skilled in the art will appreciate that the second bearing 241 may optionally be the same in size to the first bearing 221.

The first bearing 221 can be configured to attach to the first endplate 220. The second bearing 241 engages the second endplate 240. The first endplate 220 is secured to the motor can 230 by a plurality of bolts 222. The second endplate 240 is similarly attached to the motor can 230 by a plurality of bolts 242. Retaining cap 212 is affixed to the first endplate 220. Magnets 231 are spaced about the inside of the motor can 230. The magnets 231 attach to the motor can 230 using adhesives. The first endplate 220 includes fingers 225 that help orient and position the magnets 231. The retaining cap 212 attaches to the first endplate 220. The motor assembly 200 is preferably sealed to prevent debris, liquids and other contaminants from entering the assembly 200. The rotor assembly of the retaining cap 210, which is formed by the first endplate 220, bolts 222, magnets 231, motor can 230, second endplate 240 and bolts 242 rotates about the stator assembly formed by the bolt 223, stator 251, axle 250, and spacer 252. Friction due to rotation is decreased by use of the first bearing 221 and second bearing 241.

The motorized wheel 110 can consist of the motor assembly 200, described above, and tire 260. The tire 260 can come in different shapes for use on/in different mediums. The tire 260 can be made out of polyurethane or similar materials. The tire 260 can be made out of plastics and/or rubbers that have different durometers. The tire 260 can contain features that interact with opposing features on the motor can 230 to transmit motor torque. The tire 260 can be constrained by the retaining cap 210 and second endplate 240. In this embodiment, the tire 260 can be changed by only removing the retaining cap 212.

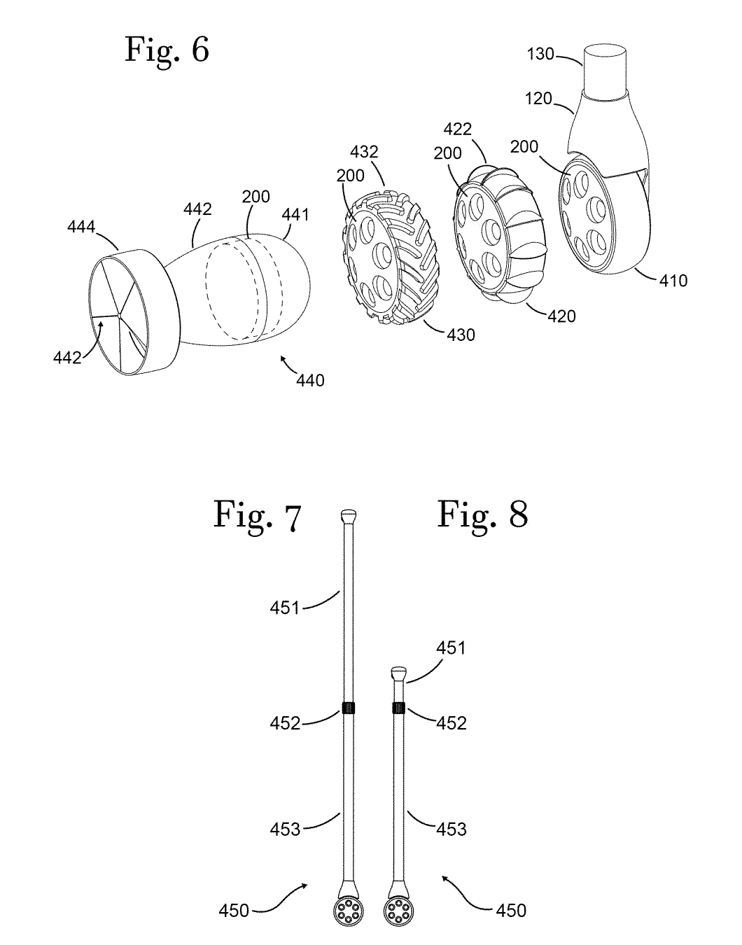

FIG.6 shows alternative embodiments of tires 410, 420 and 430 that are interchangeable with tire 260 in accordance with the principles of the invention. The tire 410 has a relatively smooth surface and is shown attached to the motor assembly 200. The tire 420 is an alternative embodiment of a tire having a plurality of radially extending blades 422 which can be attached to the motor assembly 200. Tire 420 may be desirable for certain types of terrain, for example sand or snow. Another alternative tire 430 includes tread 432 that may be desirable for uneven or rough terrain. The tire 430 with tread 432 can be made from one piece. The tire 430 with tread 432 can be made out of rubber or similar materials. Additional alternative embodiments of tires may have different diameters and different tread patterns for different riding characteristics.

FIG. 6 also shows a propeller assembly 440 which can be placed over the motor assembly 200 and a portion of the mounting arm 120. The propeller assembly 440 can be used to provide auxiliary propulsion in water. In this embodiment, the propeller assembly 440 has a shroud 444 over propeller 442 The nacelle 441 can provide reduced drag and direct the flow around the mounting arm 120. The shrouded propeller 442 can be configured to attach to the motor assembly 200 and rotate with it. The shrouded propeller 442 and nacelle 441 can be made from hard plastic. The shrouded propeller 442 and nacelle 441 can be made from a toughened plastic such as fiber reinforced nylon. The shrouded propeller 442 can contain a plurality of blades. The shroud 444 can contain a protective duct/ring surrounding the blades of propeller 442 which direct the flow and protects it from obstacles, whether animate or inanimate. The propeller assembly 440 can have different levels of buoyancy.

FIGS. 7 and 8 show a telescoping auxiliary propulsion device 450 in an extended configuration and a retracted configuration. The telescoping auxiliary propulsion device 450 has an upper portion 451, lower portion 453, and adjustable coupling 452 lock. The upper portion 451 and lower portion 453 can have different sizes so one can encompass the other. The cross section of the upper portion 451 and lower portion 453 may be round. The cross section of the upper portion 451 and lower portion 453 optionally be an octagon, an airfoil, or other shape. The adjustable coupling 452 lock is used to tighten the upper portion 451 to the lower portion 453 to lock in a plurality of positions. The telescoping device 450 produces a configuration that is infinitely adjustable. FIG. 7 shows the telescoping device 450 in its fully extended configuration, and FIG. 8 shows the telescoping device 450 in its fully retracted configuration.

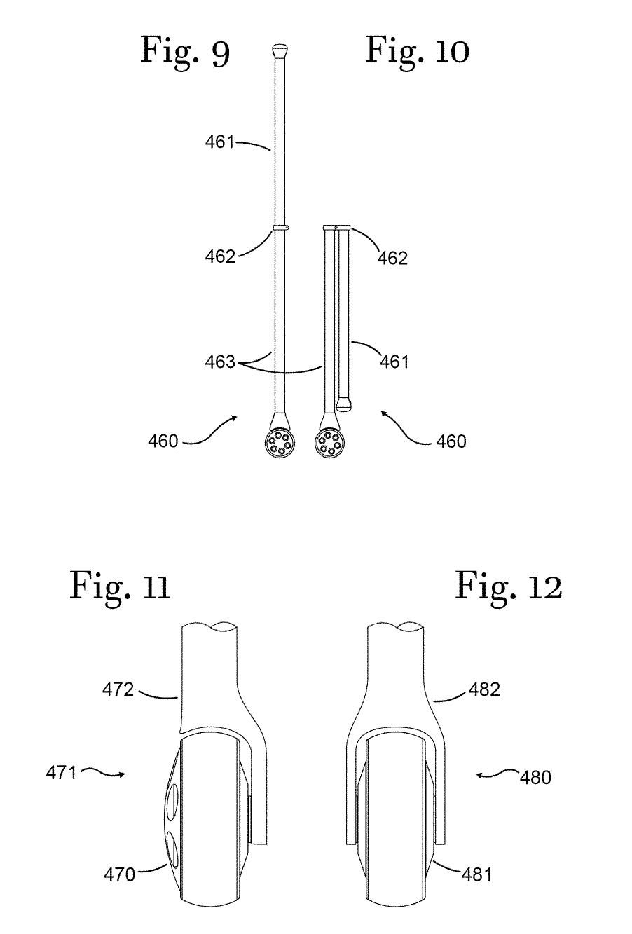

FIGS. 9 and 10 shows a folding auxiliary propulsion device 460 having a top portion 461, a bottom portion 463, and a pivoting coupling mechanism 462. The pivoting coupling mechanism 462 translates between two configurations, open and closed. FIG. 9 shows the device 460 in the open state. FIG. 10 shows the device 460 in the closed state. The pivot coupling 462 can contain a mechanism to lock the folding mechanism 460 in both states. The pivot coupling 462 can contain two or more parts.

FIGS. 11 and 12 show two alternative embodiments of mounting arms in accordance with the principles of the invention. The mounting arm 472 of FIG. 11 includes only a single point of attachment for the wheel 470. FIG. 12 shows a mounting arm 482 that attaches to a wheel 481 at each of the two opposing ends of the axle.

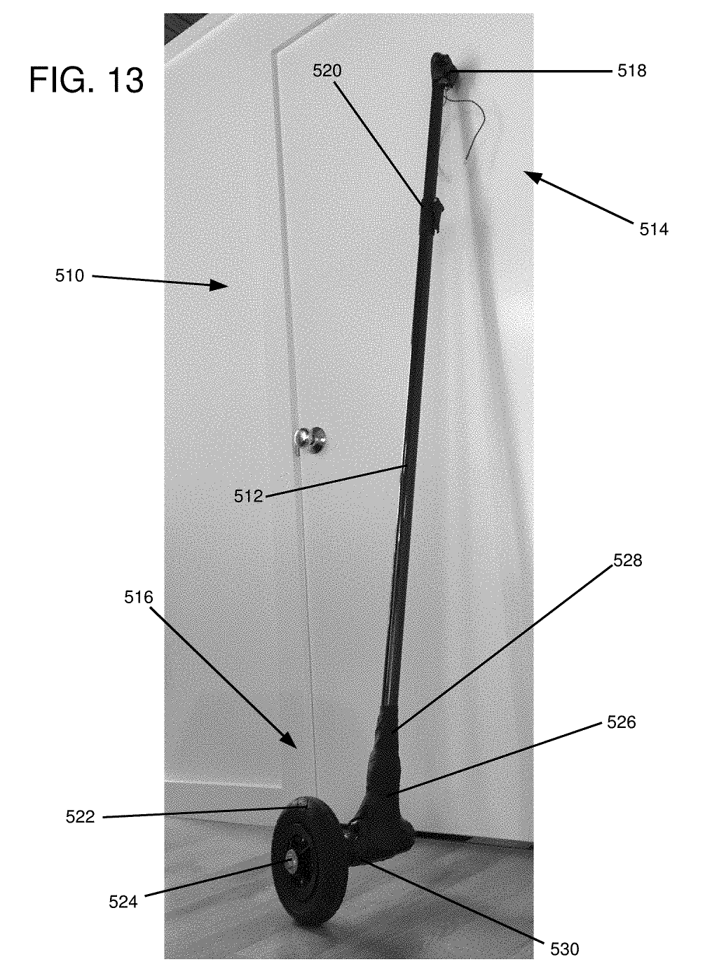

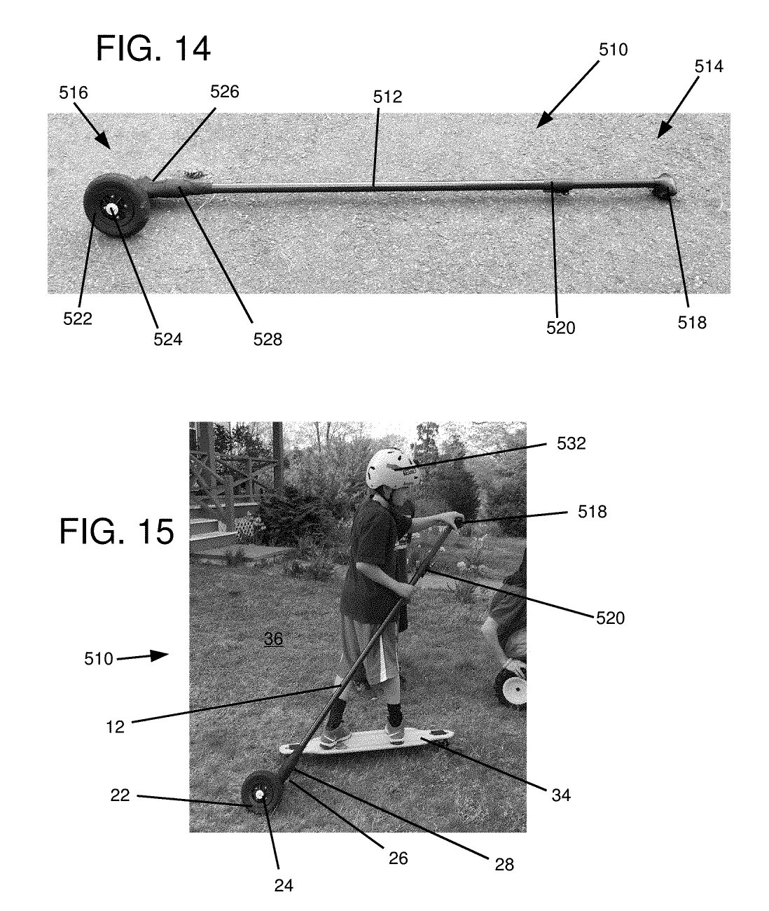

FIGS. 13-15 show an auxiliary propulsion system 510 for a skateboard in accordance with the principles of the invention. The propulsion system includes an elongate pole 512 having a proximal end 514 and a distal end 516. In this embodiment, the proximal end 514 includes a handle 518 configured as a transverse bar perpendicular to the pole 512, providing a “T” shape, ergonomically designed to be grasped by a skateboarder with one hand. A controller 520 is positioned medial to the handle 518. Optionally, the control mechanism 520 may include a secondary handle where a skateboarder grasps the pole 512.

The distal end 516 has a wheel 522 affixed to an axle 524 and is actuated by a motor 526. In this embodiment, a battery 528 is positioned medial to the motor 526, which is an electrical motor. The controller 520 may be used by a skateboarder to adjust the torque force output of the motor 526. The auxiliary propulsion system 510 may optionally include a transmission 530 coupled to the axle 524 and the motor 526. The device may also optionally include a braking system.

During use, a skateboarder may place the wheel 522 on the grounds next to the skateboard and actuate the motor in order to propel the skateboard forward or backward. The axle 524 may be coupled to the motor 526 such that it resists rotation when the motor is turned off. Optionally, the axle 524 may be coupled to the motor 526 such that the wheel 522 spins freely in one or both directions when the motor 526 is turned off. Those skilled in the art will appreciate that this type of coupling may be accomplished using well-known mechanisms in the art, such as rotational mechanisms used in screwdrivers as well as bicycle gears. The controller 520 may modulate the power to the motor 526 to allow a skateboarder to adjust the speed and/or torque force applied by the motor in order to adjust the amount of propulsion provided to the skateboarder in the skateboard.

One advantage of the embodiment shown is the relative ease with which a skateboarder may adjust the direction of the propulsion force applied by the wheel 522. A skateboarder may rotate the device along a longitudinal axis parallel to and centered around the pole 512 so that the wheel is aligned parallel to the skateboard or at an angle. By rotating the auxiliary propulsion system 510, additional force may be applied when making a turn or performing a stunt. Thus, the propulsion system 510 may be used to increase or counteract centrifugal force, centripetal force, angular acceleration and/or angular momentum. It may be preferable to utilize an electric motor because of its ability to immediately provide a desired torque force across a wider range and more quickly than other types of motors. Optionally, a motor may be powered by other means such as for example a gasoline engine, a tension mechanism such as a spring or rubber bands, or may be powered directly by a skateboarder.

A skateboarder may also exert a force along the polls to further attenuate the direction and type of propulsion force applied to the grounds. For example, a skateboarder may push down on the pole during use to provide additional frictional force when applying the wheel 522 to a relatively slippery surface. Optionally, a skateboarder may apply the wheel in one direction, for example parallel to the skateboard, while also applying a force transverse to the skateboard and wheel manually by pushing on the handles. Optionally, the pole 512 may have one or more curved regions. However, in this embodiment it is preferable to utilize a straight pole to maximize transfer of downward force along the pole and into the wheel in order to adjust the frictional engagement of the wheel with the surface over which a skateboarder is traveling. Because the propulsion device 510 is not a fixed in any way to the skateboard, a skateboarder may use the device 510 in many different ways. The propulsion system 510 may even be used to apply force to a wall or even ceiling instead of the ground.

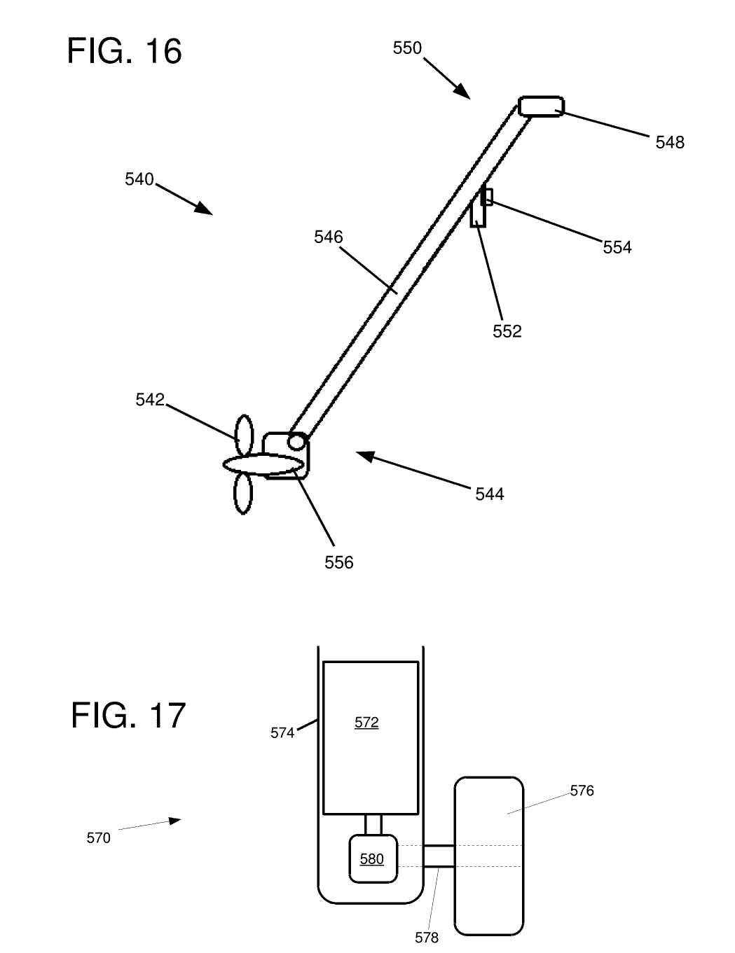

FIG. 16 shows a skateboarder 532 riding a skateboard 534 while engaging the wheel 522 of the auxiliary propulsion system 510 with the ground 536. By pushing down word on the handle 518, the skateboarder 532 may increase the frictional engagement between the wheel 522 and the ground 536. The skateboarder 532 may grip the pole 512 with his or her other hand to adjust the position, direction, and force applied to the pole by the skateboarder 532 to impart the desired force in the desired direction on the ground using the wheel 522.

FIG. 16 shows an alternative embodiment of an auxiliary propulsion system 540 configured for use with a paddleboard, surfboard, kayak or other floating device. The auxiliary propulsion system 540 is very similar to the system 510 shown in FIGS. 13-15. However, instead of utilizing a wheel, a propeller 542 is positioned at the distal end 544 of the pole 546. A first handle 548 is located at the proximal end 550 of the pole 544. A second handle 552 is positioned medial to the first handle 548 but is still generally near the proximal end 550 of the pole 544. The second handle 552 may include a controller 554 for adjusting the torque force applied by a motor 556 to the propeller 542. As with the propulsion system 510 of FIGS. 13-15, the propulsion system 540 is in no way affixed to the paddleboard, kayak or other watercraft. This gives a person on board the watercraft substantially more control over the direction and amount of force applied by the system 540.

FIG. 17 shows an alternative embodiment of an auxiliary propulsion system 570 having a motor 572 located entirely inside the pole 574. The motor 572 is connected to the axle 578 of the wheel 576 by a universal joint 580. The wheel 582 is to the side of the pole 574. This configuration may be more suitable for use with a motor having an elongate shape that may provide more power.

Because propulsion systems as disclosed herein are not a fixed to a skateboard, watercraft or other device, it is readily transferable from one vehicle to another and from one rider to another at any time, even while two different travelers are utilizing two different devices.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1-17. (canceled)

18. An auxiliary propulsion system comprising:
an elongate pole having a proximal end and a distal end;
a handle at the proximal end;
a motorized wheel at the distal end;
a trigger control unit proximate to the proximal end;
a motor controller proximate to the distal end;
a battery pack; and, a motor;
wherein the trigger control unit, the motor controller and the motor regulate the speed of the wheel; and,
wherein the battery pack is housed within the elongate pole.

19. The auxiliary propulsion system in claim 18, wherein the motor is housed entirely within the motorized wheel.

20. The auxiliary propulsion system in claim 18, wherein the motorized wheel is direct driven.

21. The auxiliary propulsion system in claim 18, wherein the motorized wheel is coupled to the motor through a geared drivetrain.

22. The auxiliary propulsion system in claim 18, wherein the motor is located in the distal end of the elongate pole.

23. The auxiliary propulsion system of claim 18, wherein the wheel further comprises a removable first tire having a smooth outer surface and which is interchangeable with a second tire having a plurality of radially extending blades, a third tire having a different tread pattern and a propeller assembly configured to provide propulsion in water.

24. The auxiliary propulsion system of claim 20, wherein the motorized wheel is attached to a single mounting arm at the distal end of the elongate pole.

25. The auxiliary propulsion system of claim 20, wherein the motorized wheel is attached to opposing mounting arms at the distal end of the elongate pole.

26. The auxiliary propulsion system of claim 18, wherein the handle is radially symmetric.

27. The auxiliary propulsion system of claim 18, wherein the trigger control unit allows the speed of the wheel to be adjusted over a continuous range.

28. The auxiliary propulsion system of claim 18, wherein the battery pack is a removable and replaceable battery.

29. The auxiliary propulsion system of claim 18, wherein the elongate pole has a telescoping mechanism to adjust the length of the device.

30. The auxiliary propulsion system of claim 18, wherein the elongate pole has a folding mechanism to adjust the length of the device.

31. The auxiliary propulsion system of claim 18, wherein the elongate pole has a circular cross section.

32. The auxiliary propulsion system of claim 18, wherein the elongate pole has a polygonal cross section.

33. The auxiliary propulsion system of claim 18, wherein the elongate pole has an airfoil cross section.
